(19) United States
(12) Patent Application Publication
(10) Pub. No.: US 2006/0151577 A1
(43) Pub. Date: Jul. 13, 2006

(54) Method and device for joining a planar component to a hollow section

(76) Inventors: Kai-Uwe Dudziak, Stelle (DE); Ulrich Haag, Aalen (DE); Stefan Schwarz, Luenen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/524,588

(22) PCT Filed: Jul. 24, 2003
(86) PCT No.: PCT/EP03/08107

§ 371 Date: Oct. 28, 2005

(30) Foreign Application Priority Data
Aug. 16, 2002 (DE) 102 37 422.8

(51) Int. Cl. B23K 20/12; B23K 31/02

(52) U.S. Cl. 228/115

(57) ABSTRACT

In a method and a device for joining a plane component to a hollow section, the component and the hollow section are inserted in an internal high pressure forming tool so as to be positioned in relation to each other and are connected through the subsequent aid of a fluidic high internal pressure in the hollow section. In order to achieve a connection between the plane component and the hollow section in a simple and process-controlled manner, while the high internal pressure is applied, the walls of the hollow section and the component, which rest against and are supposed to be connected with each other, are pressurized by a die that is integrated in the forming tool. The wall of the hollow section is punched so that the created slug is attached in a positive bonding manner to one area of the hole edge and increase in terms of its width towards its free end. A section in the form of a link, which has the same shape as the slug, is bent out of the wall of the component into the hollow section in a position that undercuts the hole edge of the hollow section.

### BACKGROUND AND SUMMARY OF THE INVENTION

This invention relates to a method for joining a plane component to a hollow section, and to a device for performing that method.

One such method and/or device is known from German document DE 196 18 626 C2. In that document, a method is described in which, in an internal high-pressure forming tool, among other things, a plane component (FIG. 5) is joined to a hollow profile. The hollow profile is expanded by the high internal pressure and engages positively around undercut surfaces of the component, thus creating a firm clamping connection of the two joining pieces. The undercut surfaces are formed on an anchor-like connecting element, which penetrates both joining pieces. This leads to increased part requirements for the joining connection and requires more comprehensive positioning of the pieces involved in the connection, as well as special, more complex fastening for the connecting element in terms of the apparatus.

In a joining connection furthermore known from U.S. Pat. No. 5,431,326, a plane component is first welded to a hollow profile blank, and then the assembly produced this way is placed in an internal high pressure forming tool, where it is formed into its final form through pinching and expanding operations by means of high internal pressure. This method has relatively little process control, since the weld seam can become damaged from the relatively high forming forces present during the pinching operation, which causes the component to become detached from the hollow section, if not in the forming tool, then certainly during subsequent usage of the formed assembly.

It is an object of the invention to further develop a method and/or a device of the types or type mentioned such that a connection between a plane component and a hollow section is achieved in a simple and controlled manner.

This object is achieved pursuant to the invention by features of the method and by features of the device which are claimed.

Due to high internal pressure, the component and the hollow section are provided with the best possible support laterally from the penetrating die. This prevents recesses in the walls of the hollow profile and of the component in the surrounding area of the created hole when activating the die, thus keeping the wall contours unimpaired and giving them a high quality outer surface. Secondly, the joining pieces, the hollow section, and the component are held in exact position in relation to each other at all times so that the die can form the link from the component wall in a reproducible and non-jamming manner, punch the hollow section wall and push the link into the hole while engaging behind the hole edge, without requiring particular arrangements. Due to the geometric conditions of the link, the link in the inwardly bent position has a greater width than that of the hole so that the component can no longer be pulled out of the hollow section vertically without effort. A pressure drop when creating the hole is practically avoided since the die enters the hole and travels laterally along the hole edge while largely sealing the surrounding area from the hollow section inside. Hence, the production of the connection has complete process control. The invention allows any random plane component to be joined easily with any random hollow section, particularly since connecting elements and the corresponding fixture requirements can be foregone. The component is fixed to the hollow section without great effort, wherein fixing of the parts can be incorporated economically into the procedure in an internal high pressure forming operation in which the hollow section is brought from a blank into a certain shape.

Other features of the invention are specified in the dependent claims. Several embodiments of the invention are illustrated in detail in the following drawings.

### BRIEF DESCRIPTION OF THE DRAWINGS

FIG. 1a is a cross-sectional view of a connection produced pursuant to the invention comprising a link and a slug;

FIG. 1b shows the connection of FIG. 1a in a lateral cross-sectional view;

FIG. 2a is a cross-sectional view of a connection produced pursuant to the invention comprising two links and two slugs;

FIG. 2b shows the connection of FIG. 2a in a lateral cross-sectional view;

FIG. 3a is a top view of a hollow section that is connected to a component in accordance with the invention, comprising three axially offset connecting points;

FIG. 3b shows the hollow section of FIG. 3a in a cross-sectional view with dies; and

FIG. 3c shows the hollow section of FIG. 3b in a lateral longitudinal cut.

### DETAILED DESCRIPTION OF THE INVENTION

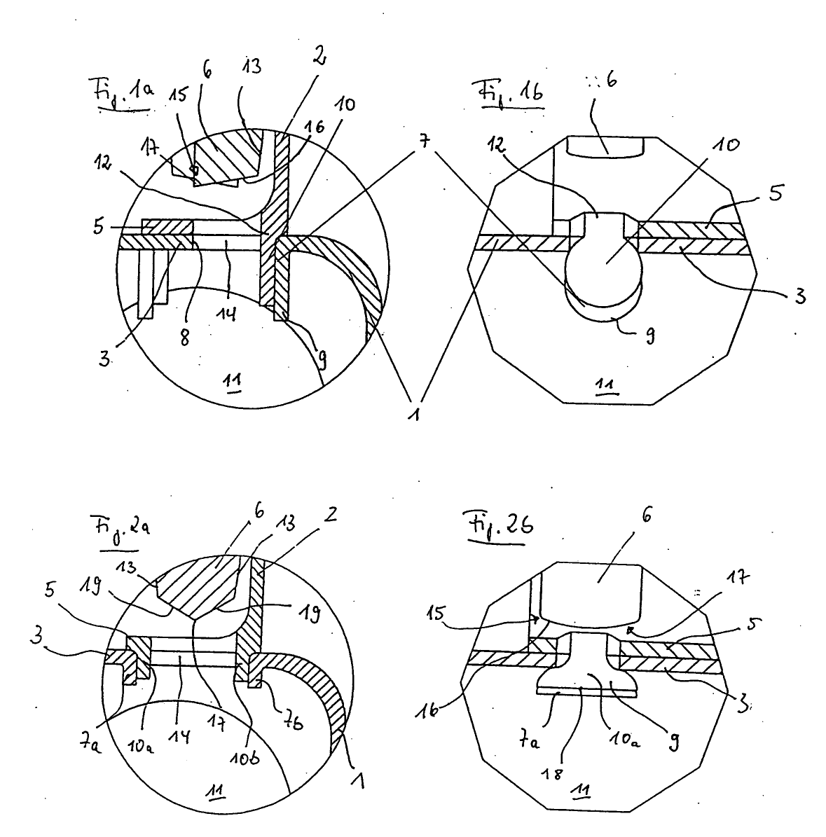

FIG. 1a illustrates a sectional view of a hollow section 1, which is joined to a plane component 2. For joining purposes the component 2 and the hollow section 1 are inserted into the cavity of a segmented internal high pressure forming tool of a joining apparatus, wherein the component 2 is positioned in relation to the hollow section 1 such that it rests thereon. The forming tool is fluidically connected to a fluid high pressure generator, via which the hollow section 1 is expanded by means of a tensile pressure fluid, wherein the hollow section wall 3 is pressed against the cavity. As long as a high internal pressure is applied in the hollow section 1, it is sealed on both ends 4 (FIGS. 3a, c) with sealing dies.

While high internal pressure is applied, the walls 3 and 5, which rest against and are supposed to be connected with each other, of the hollow section 1 and the component 2 are pressurized by means of a die 6, which is integrated in the forming tool and is displaceable in a guide incorporated there, together in a displacement motion of the die 6. The die 6 punches the wall 3 of the hollow section 1, specifically such that the slug 7 created this way is attached in a positive bonding manner in one area of the hole edge 8 and increases in terms of its width towards its free end 9. Secondly at the same time a section in the form of a link 10 that has the same shape as the slug 7 is bent out of the wall 5 of the component 2 into the inside 11 of the hollow section 1 into a position in which the link 10 engages behind the hole edge 8 of the hollow section 1. The slug 7 as well as the link 10 extend from the walls 3 and 5 in a perpendicular fashion into the hollow section 1.

The shape of the link 10 and the slug 7 can take on various designs. For example a trapezoidal shape, an oval, or circular design, the latter being shown in FIG. 1b, is possible. It is essential, however, that the link 10 is wider in one area than on its end 12 connected to the wall 5 so that in the perpendicular arched position in relation to a vertical lifting motion of the component 2 resistance is created in this wider area of the link 10 from the undercutting of the hole edge 8, said resistance ensuring that the component 2 cannot be pulled off the hollow section 1. Especially beneficial are all shapes that increase steadily in width from the end 12 in the direction of the free end 9 across the largest possible section of the link 10 since then the component 2 is fixed to the hollow section without rattling, and secondly also non-perpendicular arched positions of the link 10 enable sufficient fixing of the component 2 to the hollow section 1 in the vertical direction.

In order to increase the durability of the connection, the die 6 contains a tapered lateral wall 13 with a positive incline on the side facing the end 12 of the link 10, by means of which the link 10 is pressed together with the slug 7 when the die 6 penetrates into the hole 14 in conjunction with the counteracting high internal pressure. Pressing occurs in such a way that a spring-back motion of the link 10 from the final bending position is prevented, and hence the desired position is maintained, as well as so that, simultaneously, removal of the component 2 from the hollow section 1 due to the generated high frictional engagement between the slug 7 and the link 10 is difficult to accomplish, if such removal can be accomplished at all. The die 6 comprises for punching purposes a cutting edge 17, which runs on the edge 15 of its face 16, with which the walls 3 and 5 are equipped, and which adjoins the lateral wall 13.

The link 10 can be produced in several variations. For one, the link 10 of the component 2 can be precut prior to being inserted into the forming tool. This causes the cutting edge 17, by means of which the die 6 punches out the hole 14 as described, to be less pressurized and experience less wear. Secondly, a lower punching force is required for the die 6, which reduces the requirements for the drive of the die 6. Additionally, the slug 7 is punched out more precisely since the cutting edge 17 of the die 6 comes essentially directly into contact with the wall 3 of the hollow section 1. Alternatively, the contour of the link 10 of the component 2 can be applied to the component 2 through a stamping operation prior to insertion into the forming tool, so that the die 6 can sever the link 10 out of the wall 5 of the component 2 using only little force due to the predetermined breaking point created by the stamping operation. It is, however, also conceivable to cut the link 10 together with the slug 7 by means of the die 6, which is an economical procedure since the production of the link 10 and the slug 7 occurs in one operation. Additionally, all devices required for preparing the wall 5 for the bending out of the link 10 are eliminated.

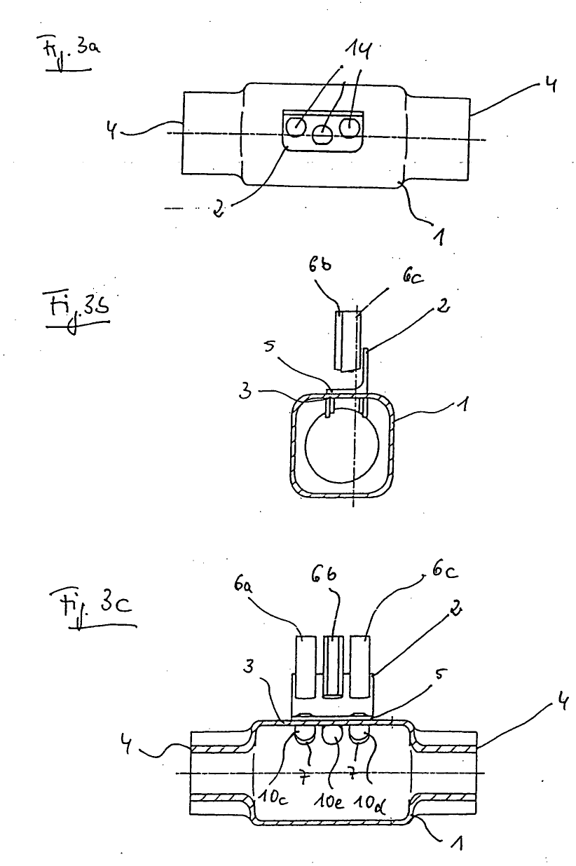

In another embodiment pursuant to FIG. 2a, the cutting edge 17 of the die 6 can also be designed such that it runs laterally on the edge 15 of the face 16 to form the two opposing slug lateral sides or, possibly, if necessary, to form the two opposing link lateral sides, and such that it extends, additionally, transversely between the end points of the lateral course (for example arranged here in the center) so that it connects the two sides with each other. In this way, when pressurizing the walls 3 and 5, the die 6 creates two links 10a, b and two slugs 7a, b, and guides them out of the walls 3, 5 of the component 2 and the hollow section 1 into their joining position in one single operation, wherein the links 10a, b, and slugs 7a, b extend into a joint hole 14 and are diametrically opposed. Each of the links 10a, b as well as the slugs 7a, b comprises straight rims 18 on the free end 9 (FIG. 2b). To displace the links 10a, b and the slugs 7a, b into the joining position, displacement chamfers 19 follow the center section of the face 16 of the die 6.

The tapered lateral walls 13 continue on these displacement chambers 19 at a steeper angle. By producing two opposing links 10a, b in the described way, lateral displacement of the respective link 10a, b—and hence separation of the component 2 from the hollow section 1—through a combination of a push motion out of the arched position, and a subsequent vertical pull-off motion is no longer possible so that the fixing of the component 2 on the hollow section 1 is improved significantly.

Moreover, it is feasible that the cutting edge 17 of the die 6 could be designed such that three slugs 7, and links 10 of equal size, are created, and such that the slugs are designed on their free ends 9 in a circular segmented fashion while extending across an angle of 120°. The undercuts of the links 10, which are required to secure the component 2 from being pulled off, are incorporated in the transition area of the link 10 from end 12 to end 9. With this design of the cutting edge, lateral displacement of the links 10 is also no longer possible. However, the design should not incorporate more than four links 10, and slugs 7 per hole 14, since then the undercut of the links 10 becomes too small for sufficient retention of the component on the hollow section 1.

In another beneficial embodiment pursuant to FIGS. 3a-c, the production device comprises three dies 6a-c that are spatially separated from each other (FIG. 3c). By means of the dies 6a-c accordingly at least one link 10 is bent out of the wall 5 of the component 2 in three separate areas, respectively, and at least one slug 7 is cut out of the wall 3 of the hollow section 1, respectively, wherein the wall 3 of the hollow section 1 is punched in accordance with the position (FIGS. 3a and c). Starting with the production of only one link 10 per hole 14, the creation of two holes 14 of equal design, and two links 10c, d of equal design, which are spatially separated from each other, by means of the dies 6a, c prevents the component 2 from twisting on the hollow section 1. As can be seen especially in FIGS. 3b and c, the third die 6b is offset by 90° in the circumferential direction in terms of its relative position to the other two dies 6a, c. Accordingly the third hole, the third slug and the third link 10e are designed in the shapes of the other two holes, slugs and links 10c, d. By offsetting the third link 10e, lateral displacement of the component 2 on the hollow section 1 is impossible.

For a process-controlled connection in the case of even component surfaces, it is beneficial if the hollow section 1 is formed by a box profile (FIG. 3b). In this way, the plane component 2 rests cleanly against the hollow section 1 already prior to the joining procedure, which is beneficial for unimpaired cutting of the slug 7, and hence also for bending the link 10 into the hole 14. In order to design the hollow section 1 as a box profile, a blank with a round cross-section is expanded into a box profile corresponding to the cavity of the forming tool in the same forming tool prior to the joining operation. It shall be noted here that the design of the plane component 2 is not limited to only even surfaces. In the case of uneven surfaces it is beneficial to adapt the hollow section 1 to the component 2 in a suitable fashion by expanding it to ensure that the parts rest cleanly against each other, and for the subsequent pressurization of the walls 3 and 5.

For a simplified insertion of the component 2 and the hollow section 1 into the forming tool, as well as for simplified fixing of the component 2 in the forming tool, it is conceivable to provisionally prejoin the component 2 to the hollow section 1 in the desired position relative to each other outside the forming tool, for example by means of gluing. This prejoining connection, however, is not associated with any special demands for durability against mechanical stress.

1-12. (canceled)

13. A method for joining a plane component to a hollow section, wherein the component and the hollow section are inserted in an internal high pressure forming tool positioned in relation to each other and are connected through the subsequent aid of a fluidic high internal pressure in the hollow section, comprising:
applying the high internal pressure, and
pressurizing the walls of the hollow section and the component, which rest against and are supposed to be connected with each other, by way of a die integrated in the forming tool so that the wall of the hollow section is punched such that a slug created in this way is attached in a positive bonding manner to one area of a hole edge and increases in terms of its width towards its free end, and so that a section in the form of a link, which has the same shape as the slug, is bent out of the wall of the component into the hollow section in a position that engages behind the hole edge of the hollow section.

14. The method according to claim 13, wherein the link of the component is precut prior to insertion of the component into the forming tool.

15. The method according to claim 13, wherein a contour of the link of the component is stamped onto the component prior to insertion of the component into the forming tool.

16. The method according to claim 13, wherein the link is cut together with the slug by way of the die.

17. The method according to claim 13, wherein when pressurizing the walls of the hollow section and the component by way of the die, two links and two slugs are guided out of the walls of the component and the hollow section into their joining positions, and wherein the links and slugs extend into a joint hole and are each diametrically opposed.

18. The method according to claim 13, wherein the link is one of several links bent out of the wall of the component in at least two separate areas, and wherein the wall of the hollow section is punched in accordance with position.

19. The method according to claim 13, wherein the hollow section is expanded into a box profile by the high internal pressure from a blank with a round cross-section.

20. The method according to claim 14, wherein when pressurizing the walls of the hollow section and the component by way of the die, two links and two slugs are guided out of the walls of the component and the hollow section into their joining positions, and wherein the links and slugs extend into a joint hole and are each diametrically opposed.

21. The method according to claim 15, wherein when pressurizing the walls of the hollow section and the component by way of the die, two links and two slugs are guided out of the walls of the component and the hollow section into their joining positions, and wherein the links and slugs extend into a joint hole and are each diametrically opposed.

22. The method according to claim 16, wherein when pressurizing the walls of the hollow section and the component by way of the die, two links and two slugs are guided out of the walls of the component and the hollow section into their joining positions, and wherein the links and slugs extend into a joint hole and are each diametrically opposed.

23. The method according to claim 14, wherein the link is one of several links bent out of the wall of the component in at least two separate areas, and wherein the wall of the hollow section is punched in accordance with position.

24. The method according to claim 15, wherein the link is one of several links bent out of the wall of the component in at least two separate areas, and wherein the wall of the hollow section is punched in accordance with position.

25. The method according to claim 16, wherein the link is one of several links bent out of the wall of the component in at least two separate areas, and wherein the wall of the hollow section is punched in accordance with position.

26. The method according to claim 14, wherein the hollow section is expanded into a box profile by the high internal pressure from a blank with a round cross-section.

27. The method according to claim 15, wherein the hollow section is expanded into a box profile by the high internal pressure from a blank with a round cross-section.

28. The method according to claim 16, wherein the hollow section is expanded into a box profile by the high internal pressure from a blank with a round cross-section.

29. A device for joining a plane component to a hollow section using an internal high pressure forming tool in a cavity of which the hollow section and the component are held in position in relation to each other with sealing dies adapted to seal ends of the hollow section, comprising:
a fluid high pressure generator by which the hollow section can be expanded using a tensile pressure fluid, comprising sealing dies to seal the ends of the hollow section, and
at least one die that is integrated in the internal high pressure forming tool and by which the component and the hollow section can be pressurized such that the wall of the hollow section is punched using a cutting edge of the die while forming an attached slug and a link is bent out of the wall of the component into the hole of the hollow section while undercutting the hole edge.

30. The device according to claim 29, wherein, on a side facing an end of the link that in a usage position is connected to the wall of the component in a positive bonding manner, the die comprises a tapered lateral wall with a positive incline, by means of which the link can be pressed together with the slug when the die penetrates into the hole in conjunction with counteracting high internal pressure.

31. The device according to claim 29, wherein the device comprises at least two separate dies.

32. The device pursuant to claim 29, wherein the die, on its face, comprises a displacement chamfer following the cutting edge.

33. The device according to claim 33, wherein the displacement chamfer is arranged on both sides of the cutting edge.
